(19) United States
(12) Patent Application Publication
(10) Pub. No.: US 2022/0110485 A1
(43) Pub. Date: Apr. 14, 2022

(54) STORAGE AND GRANULATION SYSTEM

(71) Applicant: Wilson Roberto DOS SANTOS, Matão (BR)

(72) Inventor: Wilson Roberto DOS SANTOS, Matão (BR)

(21) Appl. No.: 17/066,545

(22) Filed: Oct. 9, 2020

(51) Int. Cl. A47J 42/30; A47J 42/24; A47J 43/22; A47J 42/28

(52) U.S. Cl. CPC A47J 42/30; A47J 42/28; A47J 43/22; A47J 42/24

(57) ABSTRACT

The present invention belongs to the field of household appliances, more particularly to the field of household appliances for storing and sifting tapioca gum so that this gum reaches adequate grain size for the preparation, through mechanical processes as granulation through pressure or extrusion. The invention also brings the advantage of avoiding manual contact with the gum, allowing all the processing of the gum to happen inside a container, as for example a cup, avoiding the entrance of dirt and contaminants, as well as distributing it in a directed way, avoiding the sifted or extruded gum to be spilled out of the frying pan.

### FIELD

The present invention belongs to the field of household utensils, more specifically to the field of household utensils for sifting or granulation of tapioca gum, so that this gum reaches adequate grain size for the preparation of tapioca disks through mechanical processes as pressure granulation or extrusion. The invention also offers the benefits of working as a storage container for the gum and also avoiding manual contact with it, making all the processing of the gum happen inside the container, as a cup for example, avoiding the entrance of dirt or contaminants, as well as distributing the sifted or extruded gum in a directed way, avoiding it to be spilled out of the frying pan.

### BACKGROUND

The consumption of tapioca through the processing of gum has been increasing around the country. Basically, the tapioca gum is obtained from cassava starch or other known and adequate plants, which is processed for commercialization. In order to obtain the starch, the cassava is peeled, cleaned, ground, and it goes through many sifting and separation processes, and eventually some complement is added. When it is hydrated, this starch becomes gum, which has grain size that can be mashed, lumped, in a block, or humid powder. However, as the gum tends to agglomerate forming lumps, there is need for a second stage of mechanical processing for the preparation of tapioca, in which the gum is sifted and granulated before it is cooked, preferably on a frying pan, to ensure that it has the ideal texture. The current preparation process is done in an archaic way, considering that in the streets tapioca is processed in the open air, in many cases being pressed against the sieve using the hands, at the same time that the person making it handles money and other contaminants.

Another problem that is faced in the processing of the gum is that the compression tension against the sieve, as it is done by hand, can vary, thus creating irregular grain size in the product.

Finally there is also the disadvantage of the mess generated by the processed material. As the granules are so thin and light, they tend to be spilled out of the frying pan and onto the stove or place of preparation of the tapioca, so there is a lot of cleaning to be done after the preparation.

The tapioca gum, different from other bran or powder products, has a peculiar characteristic, which makes its processing harder. This characteristic is the fact that its composition generates adherent and binder granules that cannot be sifted in devices known in the state of the art, as in the case of the devices revealed and claimed in the American patent documents U.S. Pat. No. 2,592,850 entitled Sifter, deposited on 20 Apr. 1951; document U.S. Pat. No. 3,329,318 entitled Combination blender-dispenser for powdered materials, deposited on 10 May 1965 equally reveals a means of dry separation of a powder material, and finally constitutes the state of the art, document U.S. Pat. No. 1,955,847 entitled Flour sifter, deposited on 30 Oct. 1931, which reveals and claims a jug for sifting flour through a sieve in its bottom.

It is noted that in the documents that constitute the state of the art, the devices are indicated for the use of farinaceous products, refined sugar, or dry powders, and are not recommended for humid gum. None of them has storage of the product or means of extrusion through mechanic compression, which is the best means for processing adherent or binder gums, as it will be better described later, and are the objectives of the present invention.

So, it is objective of the present invention to provide a storage and granulation system in which the processing of the gum happens in an encapsulated container, without direct human contact with the tapioca gum.

It is also an objective of the present invention to provide a storage and granulation system in which the pressure over the gum is uniform, thus creating regular grain size in the processed material, giving a more uniform texture to the tapioca.

An additional objective of this invention is the provision of a storage and granulation system that offers a laminar exit flow for the tapioca, thus avoiding the material to be spilled out of the frying pan where it is prepared, greatly eliminating the mess while preparing tapioca gum.

These and other objectives and advantages described above are reached by the provision of a storage and granulation system for the cassava starch gum, as the gum used in the making of tapiocas, with a cup built in plastic or another material that is known and adequate, and open at both ends, so that it receives a primary ring in its superior extremity, which interlocks a second ring, and this is the one that bears a vertical stem considering the cup, providing rotation movements once you spin a handle that is at the end of the stem. At the opposite side of the handle in this stem, there is at least one fin or spade which presses the gum against a sieve installed at the bottom of the cup. There is still, at the bottom of the cup, a lid that avoids spilling material while it is being handled, so that it does not fall while the device is not being used.

### BRIEF DESCRIPTION OF THE DRAWINGS

The invention will be better described based on the drawings attached, given as an example of a possible way of idealization in which:

FIG. 01—Represents a side plan view, in section, of the storage and granulation system, object of the present invention;

FIG. 02—Represents an exploded perspective view of the storage and granulation system, object of the present invention;

FIG. 03—Represents a side plan view of the storage and granulation system, object of the present invention;

FIG. 04—Represents a side plan view of the stem set of the storage and granulation system, object of the present invention;

FIG. 05—Represents a side plan view of the inferior portion of the stem set of the storage and granulation system, object of the present invention;

FIG. 06—Represents a perspective view of the stem set of the storage and granulation system, object of the present invention;

FIG. 07—Represents a side plan view of the inferior lid used in the storage and granulation system, object of the present invention;

FIG. 08—Represents a perspective view of the inferior lid used in the storage and granulation system, object of the present invention.

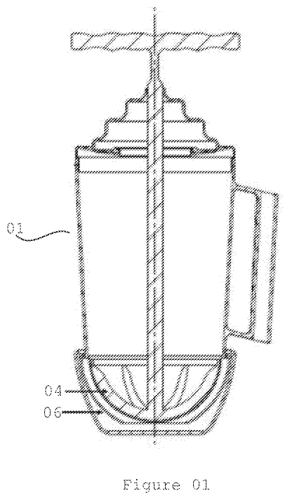

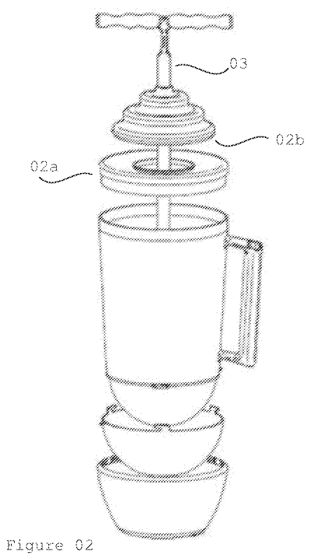

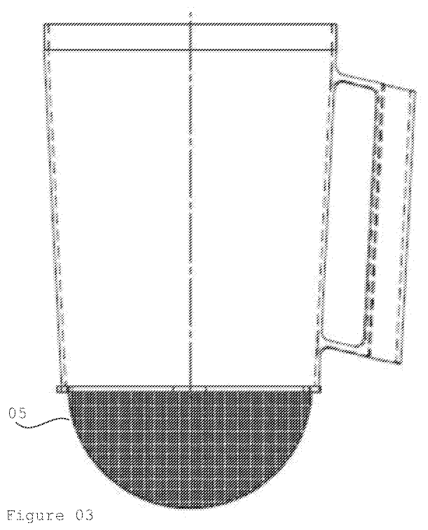

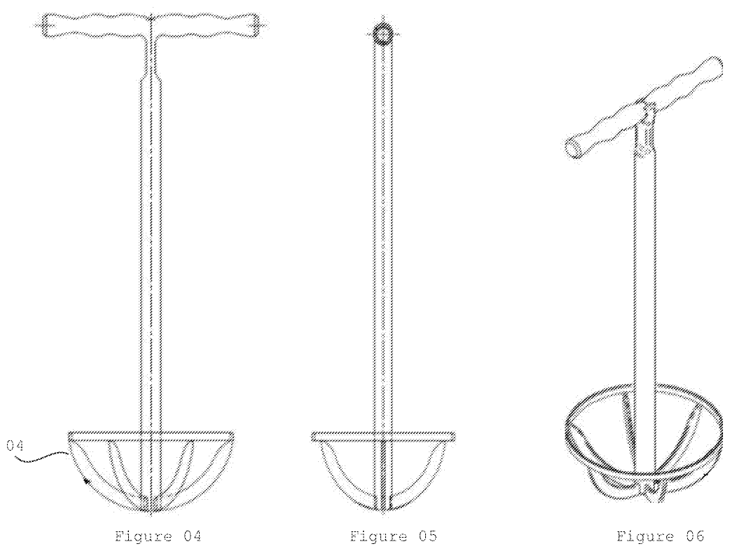

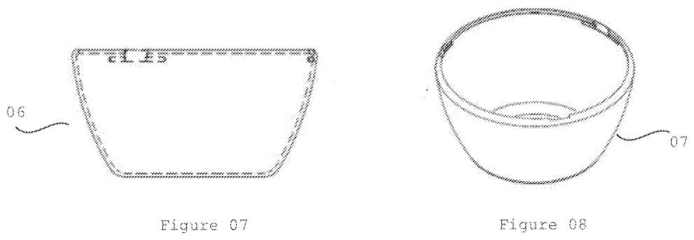

### PREFERRED CONFIGURATION

Based on the drawings and figures represented above, the present invention comprehends a storage and granulation system, made up of a cup (01), built in plastic or another well known and adequate material through processes of rotomolding, plastic injection, blow molding, or another adequate process for the conformation of plastic material. The cup (01), has its two ends open so that it surrounds the material that is inside it.

In the superior portion of the cup, (01) a primary plastic ring is assembled (02a), which has a connection to a second ring (02b), which carries in its center, through bearing, a stem (03) of vertical trajectory regarding the cup (01). The bearing of the stem (03) in the secondary ring (02b) allows the stem to have a position that is fixedly mobile, so that it has a degree of mechanical freedom in rotational, axial, radial or pendular directions.

In the extreme portion of the stem (03), there is at least one fin (04) or, alternatively, spades, which are conformed in semi-spherical geometry, flat or conical, in a way that if there is more than one fin or spade, they are inter-spaced. The fins or spades are immediately above the sieve (05) with compatible geometry to the one of the fins or spades, in a way that the material disposed between the marginal portions of the fins (04) and the sieve is processed through compression, as it will be described later.

In work stage, the storage and granulation system, object of the present invention, is assembled and receives tapioca gum in its inside in a way that the granules fill particularly the perimeter between the marginal portions of the fins (04) and the sieve (05). Once rotational, axial, radial or pendular movements are applied to the stem (03), the fins compress the material against the sieve, pressing and extruding it by the compression to the external part of the sieve, forming, through gravity, a laminar flow of tapioca granules towards the extreme inferior part of the cup (01).

The storage and granulation system, object of the present invention, also has a means of retention of the granules while storing, which happens through a lid (06) attached to the inferior portion of the cup (01), more particularly to the perimeter of the sieve (05). In a second assembly way, the lid (06) can be substituted by a flow directing funnel.

As only two preferential configurations have been described for the storage and granulation system, it is obvious that eventual changes might occur to the disposition of the present invention, especially in the different geometries of the cup and the fins or spades, which can be built in a solid or hollow way, without escaping the scope of one or more claims on the present descriptive report.

1. THE STORAGE AND GRANULATION SYSTEM comprises a cup (01) built in plastic, glass or another adequate material, through a conformation process that is known and adequate, having at least one of its ends open, characterized by the fact that the superior extremity receives a primary ring (02a), which inter-operates with a second ring (02b), considering that the center of the ring (02b) bears a stem (03) of vertical trajectory in relation to the cup (01), and in the extreme portion of the stem (03) there is at least one fin (04) or spade, conformed in flat, conical or semi-spherical geometry, with solid or hollow construction, immediately disposed above the sieve (05) of compatible geometry with the fin (04) or the spade.

2. THE STORAGE AND GRANULATION SYSTEM, according to the previous claim, is characterized by the fact that there is a lid (06) in the inferior portion of the cup.
